(19) United States
(12) Patent Application Publication
(10) Pub. No.: US 2014/0055619 A1
(43) Pub. Date: Feb. 27, 2014

(54) LUMINAIRE TO EMIT LIGHT RESPONSIVE TO AN EMERGENCY ALERT AND ASSOCIATED METHODS

(71) Applicant: LIGHTING SCIENCE GROUP CORPORATION, Satellite Beach, FL (US)

(72) Inventors: Eric Holland, Indian Harbour Beach, FL (US); Julia Sharon Irvin, Melbourne, FL (US); Eric Thosteson, Satellite Beach, FL (US); Benjamin Charles Burns, Satellite Beach, FL (US); John Beck, Satellite Beach, FL (US)

(73) Assignee: LIGHTING SCIENCE GROUP CORPORATION, Satellite Beach, FL (US)

(21) Appl. No.: 13/969,103

(22) Filed: Aug. 16, 2013

Related U.S. Application Data
(63) Continuation-in-part of application No. 13/842,875, filed on Mar. 15, 2013.
(60) Provisional application No. 61/644,152, filed on May 8, 2012.

(51) Int. Cl. G08B 5/36; H04N 7/18

(52) U.S. Cl. CPC G08B 5/36; H04N 7/181
USPC 348/159; 340/691.1

(57) ABSTRACT

A luminaire may include a wall mount, a driver circuit housing connected to the wall mount, a sensor housing connected to the driver circuit housing, a light source housing connected to the sensor housing, and a light source array carried by the light source housing. A controller may be positioned in electrical communication with an emergency alert system, a sensor carried by the sensor housing and the light source. The light source may be capable of emitting illuminating light, and the controller may be configured to receive an emergency alert from the emergency alert system. The controller may be configured to operate the light source to emit light within a wavelength range associated with a color responsive to the emergency alert and the color of the light emitted may be associated with a particular emergency.

### RELATED APPLICATIONS

This application is a continuation in part of U.S. patent application Ser. No. 13/842,875 titled SELF-CALIBRATING MULTI-DIRECTIONAL SECURITY LUMINAIRE AND ASSOCIATED METHODS filed on Mar. 15, 2013, which, in turn, claims the benefit of U.S. Provisional Application Ser. No. 61/644,152 titled SELF-CALIBRATING MULTI-DIRECTIONAL SECURITY LUMINAIRE AND ASSOCIATED METHODS filed on May 8, 2012, the entire contents each of which are incorporated herein by reference. This application is also related to U.S. patent application Ser. No. 13/234,371 filed Sep. 16, 2011, titled COLOR CONVERSION OCCLUSION AND ASSOCIATED METHODS, U.S. patent application Ser. No. 13/107,928 filed May 15, 2011, titled HIGH EFFICACY LIGHTING SIGNAL CONVERTER AND ASSOCIATED METHODS, U.S. patent application Ser. No. 13/403,531 filed Feb. 23, 2012, titled CONFIGURABLE ENVIRONMENTAL CONDITION SENSING LUMINAIRE, SYSTEM AND ASSOCIATED METHODS, U.S. patent application Ser. No. 13/464,292 filed May 4, 2012, titled INTELLIGENT SECURITY LIGHT AND ASSOCIATED METHODS, and U.S. patent application Ser. No. 13/464,345 filed May 4, 2012, titled OCCUPANCY SENSOR AND ASSOCIATED METHODS, and U.S. Provisional Patent Application Ser. No. 61/777,585 filed Mar. 12, 2013 titled EDGE LIT LIGHTING DEVICE, the entire contents of each of which are incorporated herein by reference.

### FIELD OF THE INVENTION

The present invention relates to the field of lighting devices and, more specifically, to lighting devices capable of emitting light in response to an emergency.

### BACKGROUND OF THE INVENTION

Current security-based luminaires are designed primarily to illuminate a particular area. These luminaires may also react to their surrounding environment using motion activated technology and/or vary the brightness of the light in response to the amount of ambient light present. However, these security-based luminaires are not tailored to illuminate an area in response to an emergency.

In such a case, emergency personnel are tasked with responding to the emergency as fast as possible and may be unfamiliar with the exact address. As a result, precious time could be lost while the emergency personnel are trying to find the location. In dark areas, or areas that may be obscured by smoke (in the case of a fire) emergency personnel could easily pass by the structure where the emergency is occurring. Therefore, a need exists for a luminaire that can illuminate an area and emit light in response to an emergency.

### SUMMARY OF THE INVENTION

With the foregoing in mind, the present invention is related to a luminaire able to output various types of light to respond to an emergency. The luminaire according to embodiments of the present invention advantageously provides illumination responsive to an emergency alert. Such illumination may advantageously assist emergency personnel in determining a location of an emergency. The luminaire according to the present invention may also advantageously illuminate a specific color light based on the type of emergency responsive to the emergency alert. The present invention also advantageously provides a luminaire capable of emitting light having a wavelength suitable for being visible through various obstructions such as, for example, smoke.

These and other features, benefits and advantages according to the present invention are provided by a luminaire which may include a wall mount and a driver circuit housing connected to the wall mount. The luminaire may also include a sensor housing connected to the driver circuit housing, a light source housing connected to the sensor housing, and a light source array carried by the light source housing. The light source array may include a plurality of light sources. The luminaire may further include a sensor carried by the sensor housing and a controller positioned in electrical communication with an emergency alert system, the sensor and the light source. The plurality of light sources may be capable of emitting illuminating light, and the controller may be configured to receive an emergency alert from the emergency alert system. The controller may be configured to operate the light source to emit light within a wavelength range associated with a color responsive to the emergency alert and the color of the light emitted may be associated with a particular emergency.

The controller may be configured to operate the light source to emit light in a predefined pattern. The controller may be further configured to operate the light source to emit light within a wavelength range defined as a visible light communication spectrum. The predefined pattern may be configured to conform to a visible light communication standard. The predefined pattern may be configured to transmit information to a receiving device via visible light communication. The light source of the luminaire may be a light-emitting diode (LED). The wavelength of the light emitted in response to the emergency alert may range from about 450 nm to about 495 nm.

The luminaire may further include a speaker in electrical communication with the controller. The controller may be configured to transmit emergency instructions and/or an audible alert upon receipt of an emergency alert to the speaker. The controller may be positioned in electrical communication with a network and may be configured to relay the received emergency alert via the network to a remote computerized device. The emergency alert system may be provided by a security system, a fire detection system, a smoke detection system, a carbon monoxide detection system, and/or a damage detection system.

In an alternative embodiment, the luminaire may include a first light source housing, a second light source housing and a first light source array carried by a first light source housing. The first light source array may include a plurality of light sources. The luminaire may also include a second light source array carried by the second light source housing, and that also includes a plurality of light sources. A first camera housing may be associated with the first light source housing, and a second camera housing may be associated with the second light source housing. A first camera may be carried by the first camera housing and a second camera carried by the second camera housing. The luminaire may also include a beacon comprised of one or more LEDs and a controller positioned in electrical communication with the emergency alert system, the first and second camera and the first and second light source array. The first and second light source arrays may be capable of emitting illuminating light and the controller may be configured to receive an emergency alert from the emergency alert system. The controller may be further configured to operate the light source to emit light within a wavelength range associated with a color responsive to the emergency alert, where the color of the light may be associated with a particular emergency.

A method aspect of the present invention is for emitting light associated with an emergency. The method may include detecting an emergency alert using the emergency system, receiving the emergency alert from the emergency system and operating the light source to emit light within a wavelength range associated with a color responsive to the emergency alert.

### BRIEF DESCRIPTION OF THE DRAWINGS

FIG. 1 is a perspective view of a luminaire according to an embodiment of the present invention.

FIG. 2 is a top plan view of the luminaire of FIG. 1.

FIG. 3 is a bottom plan view of the luminaire of FIG. 1.

FIG. 4 is a front elevation view of the luminaire of FIG. 1.

FIG. 5 is a side elevation view of the luminaire of FIG. 1.

FIG. 6 is an exploded perspective view of the luminaire of FIG. 1.

FIG. 7A is a schematic view of an array of LEDs to be used in a luminaire according to an embodiment of the present invention.

FIG. 7B is an alternate schematic view of an array of LEDs to be used in a luminaire according to an embodiment of the present invention.

FIG. 8 is a schematic view of an array of prisms overlaying an array of LEDs to be used in a luminaire according to an embodiment of the present invention.

FIG. 9 is a schematic side view of the array of prisms overlaying the array of LEDs to be used in a luminaire as shown in FIG. 1.

FIG. 10 is a flowchart demonstrating operation of a luminaire according to an embodiment of the present invention allowing for a manual brightness level adjustment.

FIG. 11 is a flowchart demonstrating operation of a luminaire according to an embodiment of the present invention allowing for an automatic brightness level adjustment.

FIG. 12 is a flowchart demonstrating an alternate embodiment of operation of a luminaire according to the present invention allowing for an automatic brightness level adjustment.

FIG. 13 is a schematic depiction of a model computing device to be used in connection with the luminaire according to an embodiment of the present invention.

FIG. 14 is a schematic model of an exemplary user interface to be used in connection with the luminaire according to an embodiment of the present invention.

FIG. 15 is a perspective view of a luminaire according to an alternative embodiment of this invention.

FIG. 16 is a perspective view of a luminaire according to a further embodiment of the invention.

FIG. 17 is a flowchart demonstrating a method for detecting an object and activating a luminaire according to an embodiment of the present invention.

FIG. 18 is a perspective view of a luminaire according to an alternative embodiment of this invention.

FIG. 19 is a flowchart demonstrating a method for detecting an emergency and activating a luminaire according to a further embodiment of the invention.

### DETAILED DESCRIPTION OF THE PREFERRED EMBODIMENT

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Additionally, in the following detailed description, reference may be made to the driving of light-emitting diodes, or LEDs. A person of skill in the art will appreciate that the use of LEDs within this disclosure is not intended to be limited to the any specific form of LED, and should be read to apply to light emitting semiconductors in general. Accordingly, skilled artisans should not view the following disclosure as limited to the any particular light emitting semiconductor device, and should read the following disclosure broadly with respect to the same.

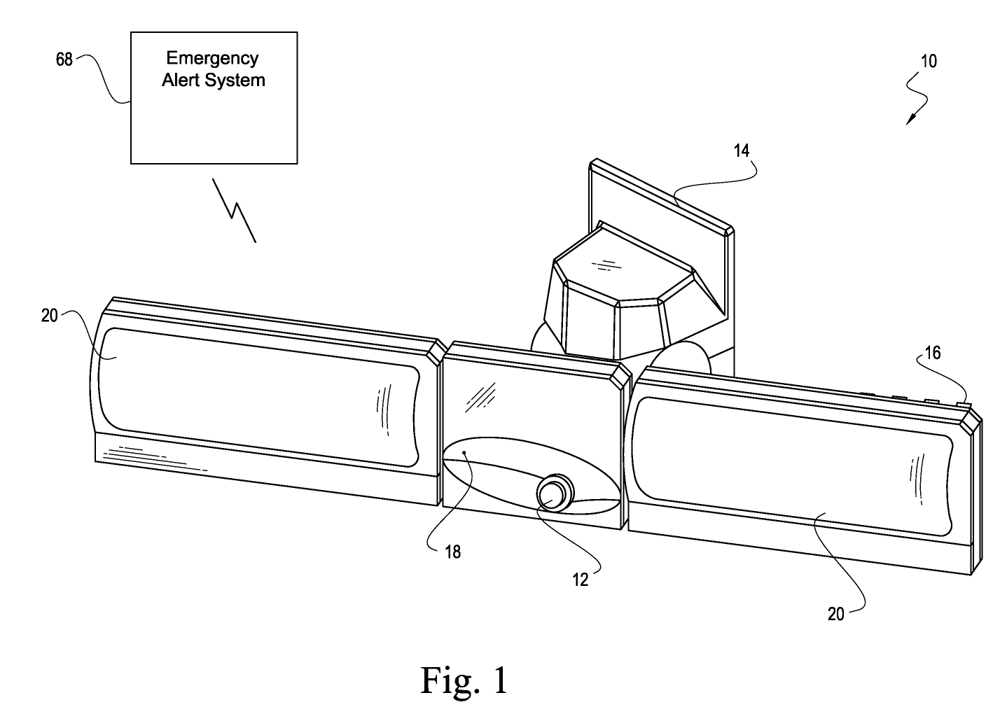

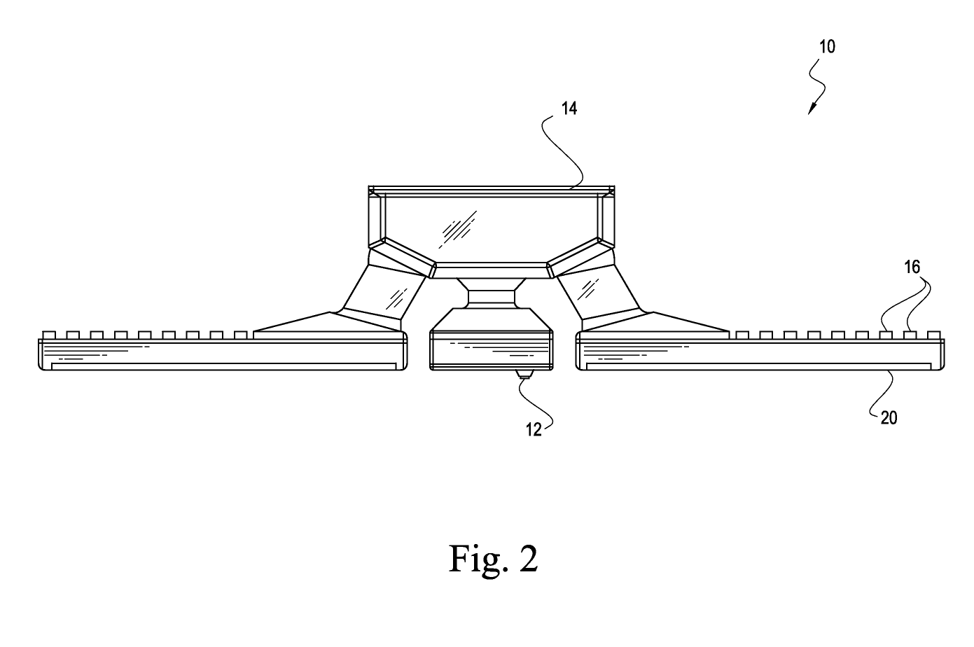

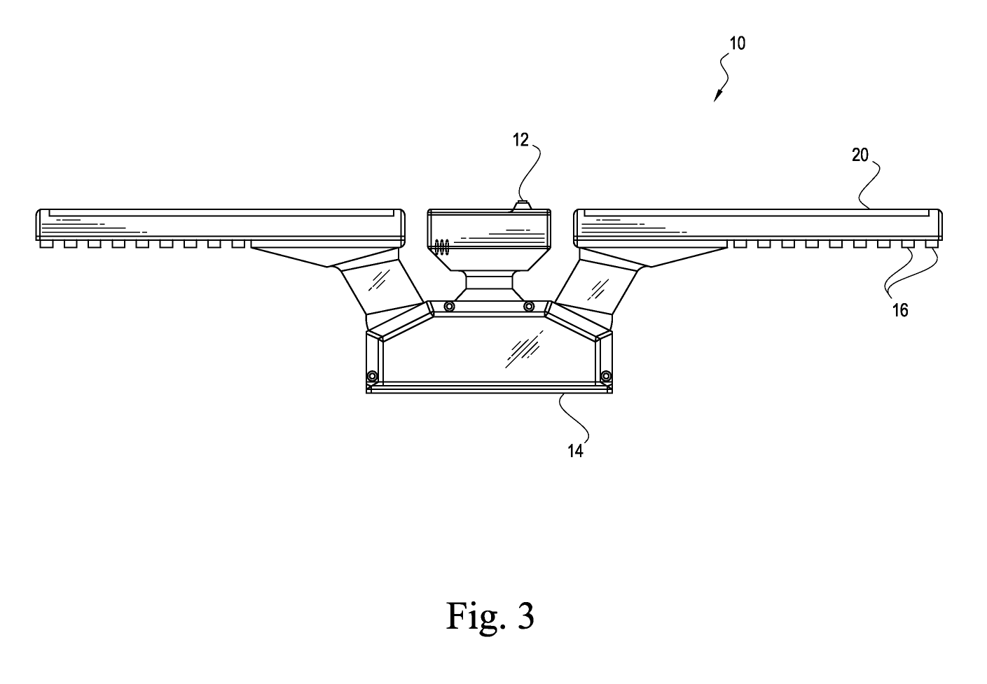

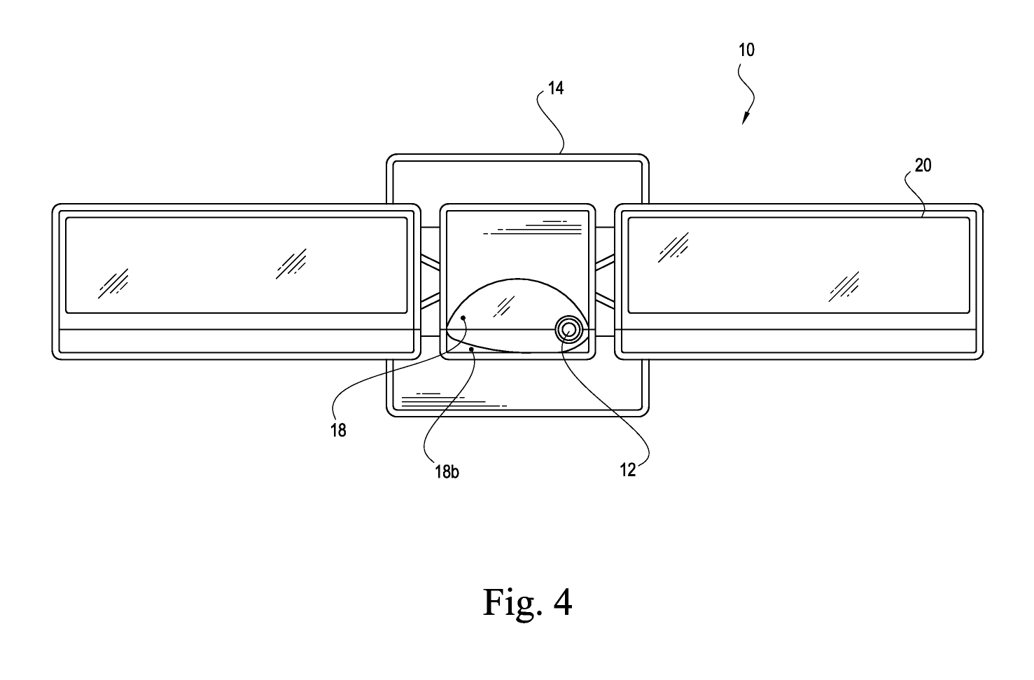

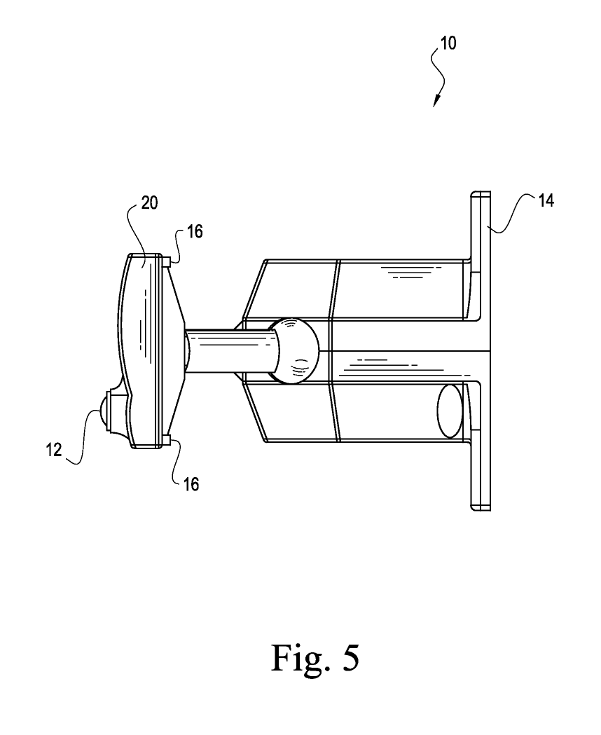

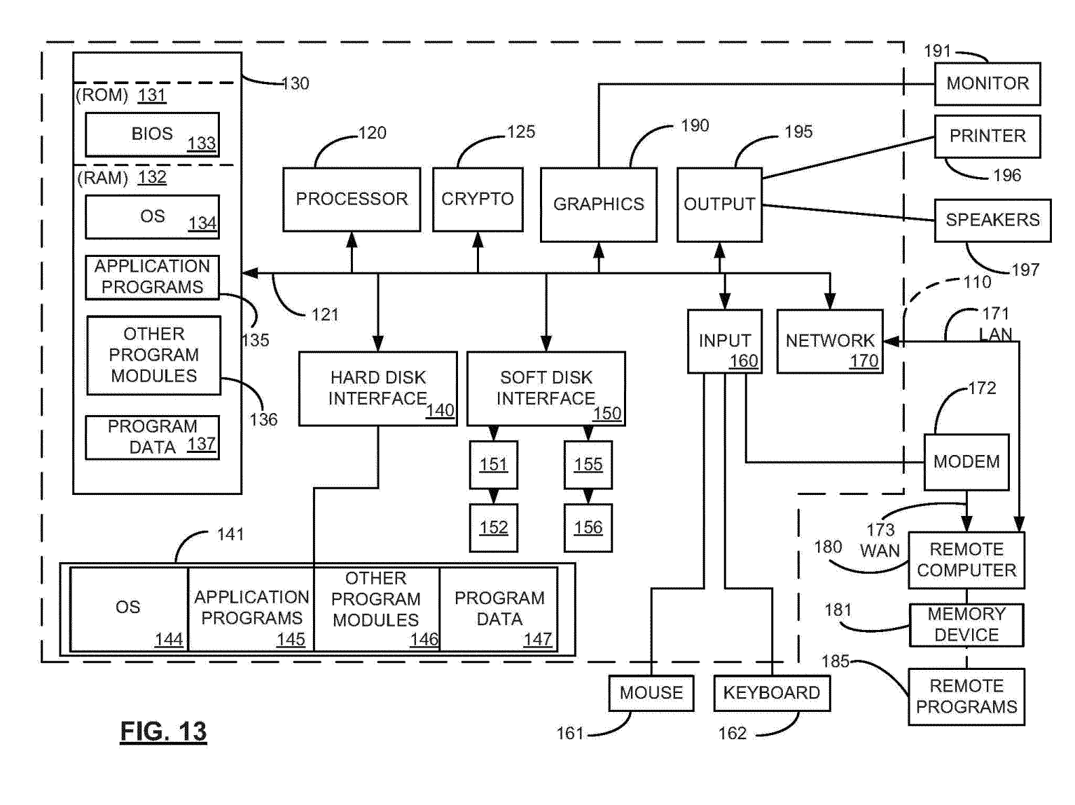

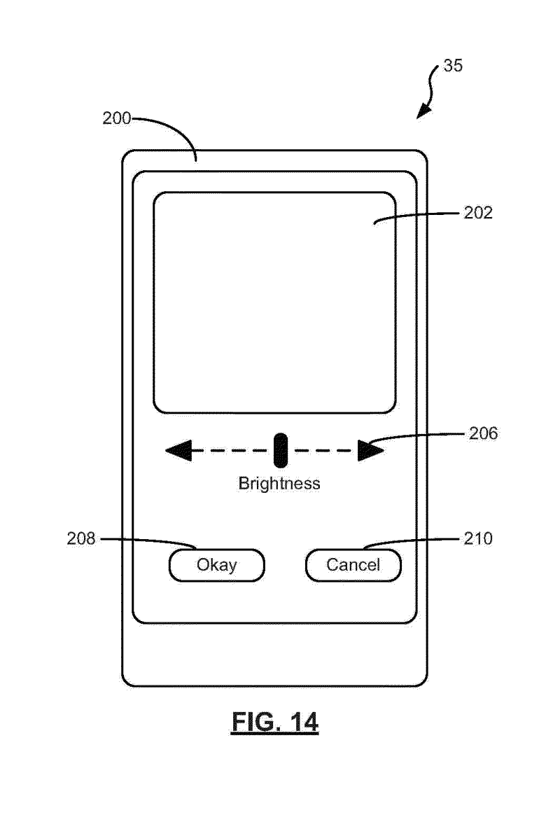

Referring now to FIGS. 1-13, a self-calibrating multi-directional luminaire 10 will be discussed. As shown in FIG. 1, the luminaire 10 may include a camera 12, a wall mount 14, a heat sink 16, a sensor 18, and LED housings 20. The terms LED housing and light housing are used interchangeably. Referring additionally to FIGS. 2 and 3, the heat sink(s) 16 may be seen in greater detail in relation to the wall mount 14, the LED housing 20, and the camera 12 of the luminaire 10. Referring also to FIGS. 4 and 5, the heat sinks 16 may be positioned on the back side of the luminaire 10 generally facing the wall mount 14 and generally opposite the LED housing 20, the camera 12, and the sensor 18. A skilled artisan will appreciate, after having had the benefit of this disclosure, that the heat sinks 16 may be positioned on the luminaire 10 in any number of ways that may dissipate heat in order to maximize efficiency.

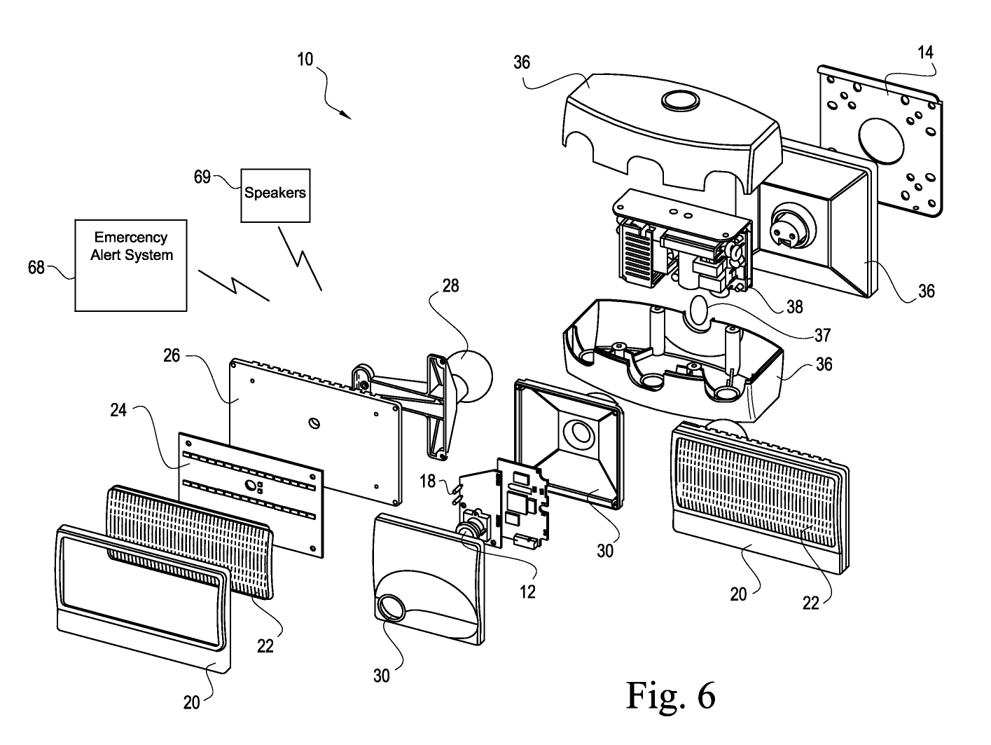

Referring now to FIG. 6, a luminaire 10 is presented in greater detail. The LED housings 20 may contain a prism 22, which may overlie an LED array 24. The terms LED array and light source array are used interchangeably, and the terms LED housing and light source housing are also used interchangeably. The light source array 24 may include a plurality of light sources. The LED array 24 may be backed by a heat sink 16 and may be integrated into the light source housing 20. Additionally, the arm 28, may connect the LED housing 20 to the rest of the luminaire 10. The camera 12 and the sensor 18 may be housed in camera housing 30, which, along with the arm 28, may connect to a driver circuit housing 36. The driver circuit housing(s) 36 may be configured to house a driver circuit 38, and may be configured to be positioned adjacent to the wall mounting such that the driver circuit housing 36 backs up to the wall mounting 14. Many additional configurations of the luminaire 10 may readily come to mind of one skilled in the art having had the benefit of this disclosure, including an LED housing without a prism 22, and are included within the scope of the invention. The LED array 24 may be implemented with a plurality of LEDs or a plurality of any light source known in the art to a skilled artisan.

Referring now additionally to FIG. 6, another embodiment of the present invention is now described. In this embodiment, the luminaire 10 may also be adapted to emit a particular light, a pattern of light, a sequence of light, or a particular wavelength of light responsive to detection, or an indication, of an emergency. In this embodiment of the luminaire 10, the sensor 18 may be configured to detect an emergency and communicate with the controller to cause the light sources to emit light. The sensor 18 may be configured to detect a plurality of emergency situations that may include a burglary, an intrusion, a fire or carbon monoxide alert, a medical emergency or damage to the premises. Those skilled in the art will appreciate that this list is not meant to be limiting, and that the luminaire 10 according to this embodiment of the invention is capable of detecting any type of emergency.

A skilled artisan will appreciate that the configuration of the elements as illustrated in FIG. 6 may be modified without departing from the scope of the invention. For example, an alternate embodiment of the invention may include a wall mount 14, a driver circuit housing 36, a sensor housing (illustrated as 18b in FIG. 4) and a light source housing 20. The driver circuit housing 36 may be connected to the wall mount 14, the sensor housing may be connected to the driver housing 36, and the light source housing 20 may be connected to the driver housing 36. Although this represents a different orientation than described above, those skilled in the art will appreciate the luminaire may advantageously operate to provide illumination responsive to detection of an emergency alert, as will be discussed in greater detail below. Additionally a light source array 24, including a plurality of light sources, may be carried by the light source housing 20 and a sensor 18 may be carried by the sensor housing. A controller 37 may be positioned in electrical communication with an emergency alert system 68, the sensor 18 and the light source 24. The plurality of light sources may be capable of emitting illuminating light. The controller 37 may be configured to operate the light source 24 to emit light within a wavelength range associated with a color responsive to the emergency alert. The color of the light emitted may be associated with a particular emergency.

The controller 37 may also be configured to respond to an emergency alert transmitted by the emergency alert system 68. The emergency alert system 68 may transmit an emergency alert triggered by a smoke/fire sensor or a carbon monoxide sensor. An emergency alert may also be triggered by damage to a dwelling or a building or a burglary alarm. An emergency alert may also be triggered by a medical emergency. A user may also opt to trigger an emergency alert if the need arises. An emergency alert may also be triggered remotely by the use of a mobile device or computer. The controller 37 may also be configured to operate the light source to emit light within a wavelength range associated with a color responsive to the emergency alert, where the color of the light emitted may be associated with a particular emergency.

The controller 37 may be configured to operate the light source in a predefined pattern. The controller 37 may cause the light source to rotate or remain steadily burning to signal an emergency. The controller 37 may also cause the light source to operate as a strobe light. A skilled artisan will appreciate that a light source including LED lights may be programmed with a wider variety of flash patterns because of their ability to be switched directly by electronics.

When the controller 37 responds to an emergency, the controller 37 may operate the light source to emit light within a wavelength range defined as a visible light communication spectrum with a predefined pattern that is configured to conform to a visible light communication standard. The predefined pattern may be configured to transmit information to a receiving device via visible light communication. The light source may be caused to emit a code during an emergency such as, for example, an SOS signal via Morse code. A visible light communication standard may be defined by the laws governing the premises where the system is installed and/or organizations that outline protocols for using emergency lights.

In the event of a fire emergency, the light source may also emit light substantially within a particular wavelength where the light emitted is selected because of favorable properties in regard to penetrating smoke particles. Those skilled in the art will appreciate that the use of the term “substantially” when describing the wavelength of the emitted light is meant to be inclusive of any wavelength of light that has advantageous properties regarding the ability of the light to penetrate smoke particles. The wavelength of the light selected may vary depending on the density of the smoke as detected by the emergency alert system. During an emergency, the default setting for the controller 37 may be to emit a light of wavelength substantially between a range of 450 nm to 495 nm. Those skilled in the art will appreciate that the use of the term “substantially” when describing the wavelength of emitted light is meant to be inclusive of any wavelength that includes blue light. The wavelength of blue light lies primarily within 450 nm to 495 nm. In an alternative embodiment, the wavelength of the light emitted during an emergency may only be limited by the bounds of the visible light spectrum. A skilled artisan will appreciate that a user may customize the default setting of the light source so that the controller 37 may emit light of a wavelength range desired by the user during an emergency. A skilled artisan will also appreciate that a user may select the wavelength range for light emitted so that the light emitted varies in accordance with the type of emergency detected.

The controller 37 may also be in electrical communication with a plurality of speakers 69 where the controller 37 may be configured to transmit to the plurality of speakers a set of emergency instructions and/or an audible alert upon receipt of an emergency alert. The emergency instructions may inform people of an impending emergency so that they may evacuate the premises. The controller 37 may also be positioned in electrical communication with a network. The controller 37 may be configured to relay a received emergency alert via the network to a remote computerized device. The remote computerized device may be a computer such as a mobile phone, a smart phone, PDA, tablet or phablet or PC. The controller 37 may also send a message to a wearable device such as a watch, or bracelet or necklace where the message may cause the wearable device to vibrate and/or flash.

In another embodiment of the invention, a networked system of multiple emergency luminaires may operate in concert so that the instructions and type of alert received in one area of the premises may be different from the instructions received at another area of the premises. The instructions may also be customizable dynamically during an emergency so that evacuees may receive the best information during an emergency. The emergency luminaires may also be configured to automatically transmit messages regarding the emergency via various messaging protocols such as but not limited to SMS, MMS, e-mail or twitter account or other online social networks. These messages may also be modified in real-time to reflect the changing nature of the situation.

In some embodiments of the present invention, the luminaire 10 may further include a light source housing which may include a first light source housing and a second light source housing, each of which may be configured similar to the light source housing 20 described hereinabove. The light source array 24 may include a first light source array which includes a plurality of light sources carried by the first light source housing and a second light source array which includes a plurality of light sources carried by the second light source housing, each of which may be configured similar to the light source array 24 as described hereinabove. The prism 22 may comprise a first prism carried by the first light source housing adjacent to the first light source array and a second prism carried by the second light source housing adjacent to the second light source array, each of which may be configured similar to the prism 22 as described hereinabove.

The heat sink 16 may include a first heat sink in thermal communication with the first light source array and carried by the first light source housing and a second heat sink in thermal communication with the second light source array and carried by the second light source housing, each of which may be configured similar to the heat sink 16 as described hereinabove. The camera housing 30 may include a first camera housing associated with the first light source housing and a second camera housing associated with the second light source housing, each of which may be configured similar to the camera housing 30 as described hereinabove.

The camera 12 may include a first camera carried by the first camera housing and a second camera carried by the second camera housing where the sensor 18 includes a first sensor carried by the first camera housing and a second sensor carried by the second camera housing, each of which may be configured similar to the camera 12 and the sensor 18, respectively, as described hereinabove. The first and second cameras 12a, 12b and the first and second sensors 18a, 18b may be configured to detect the presence and vicinity of an object in a target area. Types of cameras that may be used as either of the first and second cameras 12a, 12b include, but is not limited to, CCD cameras, CMOS cameras, digital imaging cameras, and digital video cameras. Types of sensors that may be used as either of the first and second sensors 18a, 18b, includes, but is not limited to, light sensors, thermal sensors, infrared sensors, motion sensors, ultrasonic sensors, microwave sensors, tomographic sensors, and the like. The first and second light source arrays may be positioned within the first and second light source housings respectively to minimize the overlap of the light emitted from each light source array. Alternatively, the first and second light source arrays may be positioned within the first and second light source housings respectively to optimize the illumination of the target area.

Some embodiments of the luminaire 10 according to the present invention may include multiple elements. For example, a luminaire may include multiple light source arrays including a plurality of light sources, multiple controllers, multiple cameras, multiple sensors, multiple heat sinks and the like.

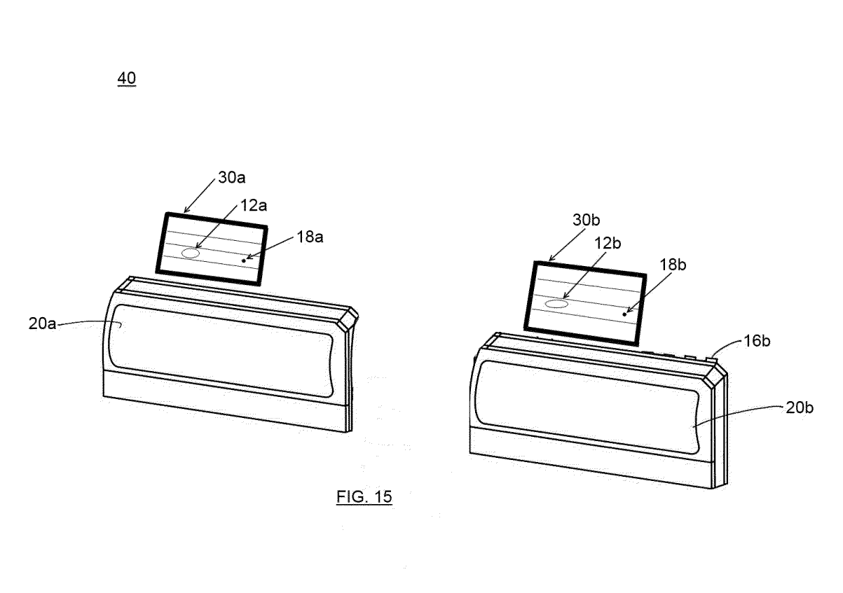

Referring to FIG. 15, an alternative embodiment of the invention is illustrated. The luminaire 40 according to another embodiment of the present invention may include a first light source housing 20a and a second light source housing 20b. The luminaire 40 may also include other elements included in the luminaire 10 of the first embodiment of the present invention, described hereinabove, such as a driver circuit housing which includes a driver circuit, a controller, an arm and a wall mount. Accordingly, and for the sake of clarity, it is to be understood, and as will be discussed in greater detail below, that the first light source housing 20a and the second light source housing 20b are connected to one another by way of the arm and wall mount that are described (but not shown in FIG. 15) above in the embodiment of the luminaire 10 illustrated and described, for example, in FIGS. 1 and 2.

Although some of the elements may not be illustrated in FIG. 15.A, the first light source array (not shown) may be carried by the first light source housing 20a where the first light source array may include a plurality of light sources. The luminaire 40 may further include a second light source array (not shown) which may be carried by the second light source housing 20b where the second light source array (not shown) may include a plurality of light sources. The first prism (not shown) which may be carried by the first light source housing 20a may be adjacent to the first light source array and the second prism (not shown), which may be carried by the second light source housing 20b may be adjacent to the second light source array.

A first heat sink (not shown) may be in thermal communication with the first light source array and carried by the first light source housing 20a. A second heat sink 16b may be in thermal communication with the second light source array and carried by the second light source housing 20b. The first camera 12a and first sensor 18a may be carried by the first camera housing 20a and the second camera 12b and second sensor 18b may be carried by the second camera housing 20b. A controller (not shown) may be in communication with the first and second cameras 12a, 12b and the first and second sensors 18a, 18b where at least the first camera 12a, second camera 12b, first sensor 18a and second sensor 18b may be configured to detect presence and vicinity of an object in a target area. At least one light source in the plurality of light sources of the first and second light source array may be configured to emit light to illuminate the vicinity of the object sensed in the target area. At least one of the first and second cameras 12a, 12b or first and second sensors 18a, 18b may generate data based on a sensed condition and the controller may operate any of the plurality of light sources from the first and second light source array based upon the data and established parameters.

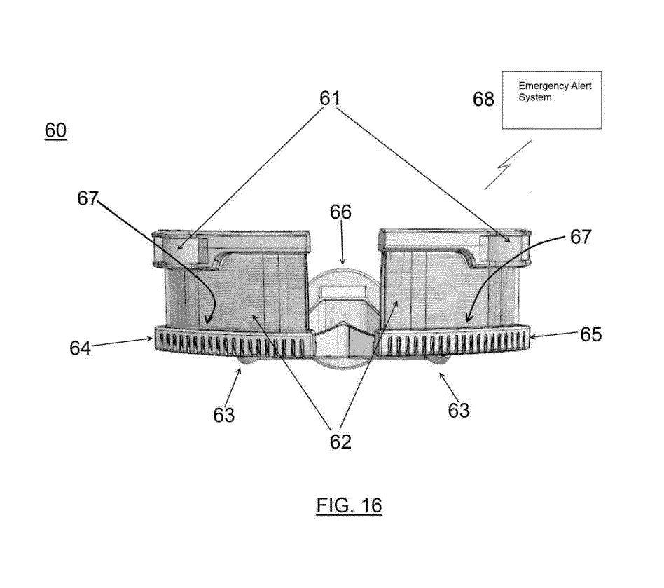

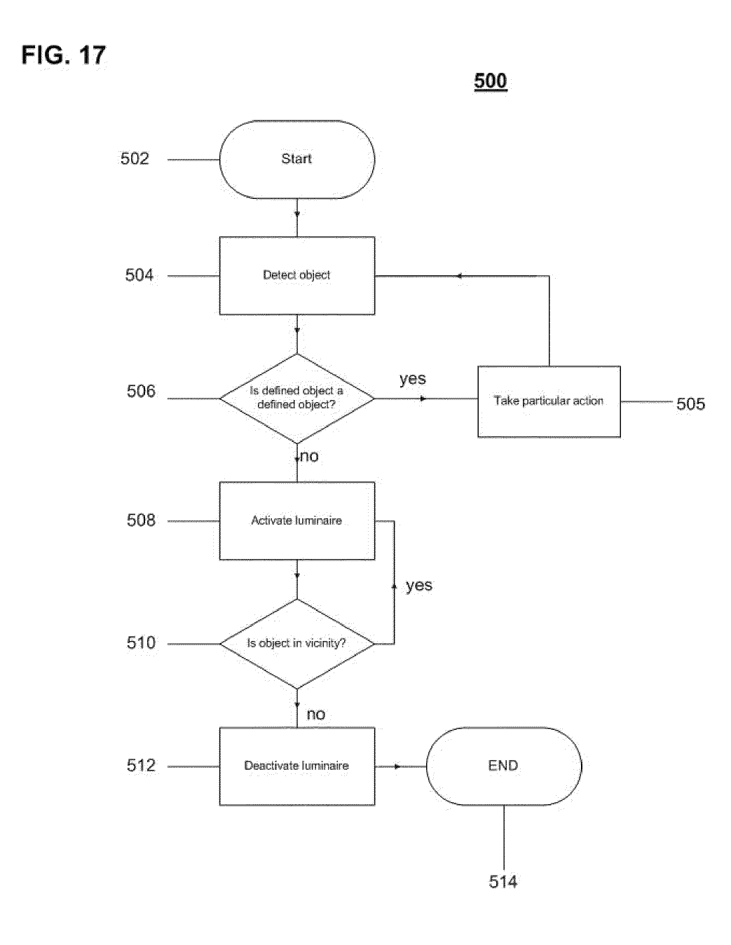

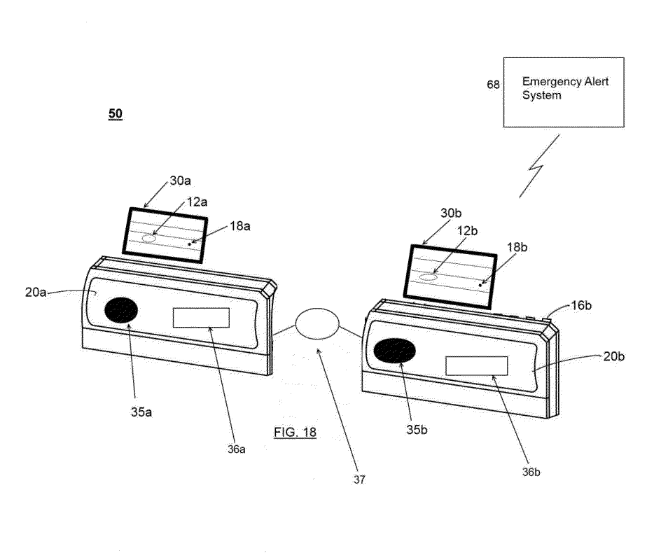

Referring to FIG. 16, yet another embodiment of the invention is illustrated. The luminaire 60 illustrated in FIG. 16 may include cameras 61, optics 62, arms 63, heat sinks 65, wall mount 66 and LEDs 67. The luminaire 60 utilizes edge lighting where the LEDs 67 are embedded at the base of the optic 62. The optic 62 is designed with ridges that are designed to redirect light from the LED 67 outward. The luminaire 60 is designed to function similarly to luminaire 10 and 40 previously described.

Referring again back to FIG. 6, detection of an object in the target area may be achieved using the camera 12, the sensor 18 or some combination of the camera and sensor of the luminaire 10 according to an embodiment of the present invention. The terms security light and luminaire may be used interchangeably herein. More particularly, those skilled in the art will appreciate that the camera 12 of the security light 10 may be used in connection with sensor 18 for sensing objects that may enter a target area. Alternately, however, the sensors 18 may be provided by any type of motion detecting device. Both the sensor 18 and the camera 12 may be positioned in communication with a controller and may generate data based on a sensed condition. The data that is generated may be processed in order to operate the security light 10 based on certain parameters or rules.

The parameters may define how long the luminaire is activated depending upon the size of the object detected, the time of the day and the type of the object detected. The controller may also utilize the parameters so that the amount of time that the target area is illuminated may be responsive to the parameters. The parameters may be set by a user or the controller may utilize default settings that may be set by a security company or a factory upon manufacture. When an object is sensed in the target area, a light source in the plurality of light sources may be configured to emit light to illuminate the vicinity of the object sensed in the target area. In an embodiment of the invention, such as is illustrated, for example, in FIG. 15, skilled artisans may appreciate that the plurality of cameras and sensors may operate in concert and/or separately so that the luminaire 40 may detect or sense objects in the target area. Skilled artisans may also appreciate that a controller may be utilized to operate the plurality of light source arrays either in concert and/or separately responsive to data regarding sensed objects in the target area.

Accordingly, the light source array 24 of the security light 10 according to an embodiment of the present invention may be set to an on state based on detection of an object, or movement, within the target area. This may be defined as an event that occurs within the target area. Further embodiments of the present invention contemplate that the security light 10 may be moved to an off state after a period of no movement, after an object is no longer detected in the target area, or after the previously sensed condition is no longer sensed. It is readily contemplated that certain objects may move in and out of the target area without the necessity of moving the light source of the security light 10 to the on state. For example, the present invention contemplates that various creatures of nature, e.g., vermin, may move in and out of the target area without the need to move the light source 24 of the security light 10 to the on state. This advantageously enhances efficiency of the security light 10 according to an embodiment of the present invention.

The present invention also contemplates that a time-keeping device may be positioned in communication with the controller. Accordingly, in some embodiments, timing data may be transmitted to the controller so that operation of the light source 24 of the security light 10 may be controlled based on the timing data. For example, the light source 24 may be turned to the on state only after an object is detected in the target area for a period of time that exceeds a threshold period of time. This too may be defined as an event, i.e., an event may include a timing component. Accordingly, this advantageously provides the security light 10 according to an embodiment of the present invention with a delay feature that provides for a delay before moving the light source 24 of the security light 10 to the on state until an object has been detected in the target area for a period of time that exceeds the threshold time, or until motion is detected in the target area for a similar period of time. Similarly, the present invention contemplates that after a period of time of detecting no motion, or object located in the target area, the light source 24 that may be moved to the off state. Further, the time-keeping device may be used to keep the light source 24 in the on state for a fixed period of time. In some embodiments, the time-keeping device may be an atomic clock.

It is also contemplated that the target area may be manipulated. More specifically, the target area may be user selected. Further, it is contemplated that the target area may be manipulated remotely through communication with the network. A user interface may be used to move the target area, change the size of the target area, or take any number of factors into account when sensing movement or detecting presence of an object in the target area. For example, it is contemplated that the target area may have a first size during a first period of time, and a second size during an alternate period of time. Similarly, it is contemplated that the target area sensed by the sensor 18 of the security light 10 may be split into an array of target areas. Accordingly, the security light 10 according to an embodiment of the present invention contemplates that various portions of the array of target areas may be activated (or selectively activated) based on any number of factors including, but not limited to, user preference, timing, or any other number of factors that may be readily understood by the skilled artisan after having had the benefit of reading this disclosure.

Referring now to FIGS. 7A-9, methods of achieving selective directional lighting according to embodiments of the present invention will now be discussed. Referring now to FIGS. 7A and 7B, arrays of LEDs 24 are presented. As shown in both figures, the LEDs 24 may be positioned in a variety of directions, including straight ahead, and may be selectively activated to emit light in a particular direction towards a detected object, if an object is detected in a target area. Additionally, a user may turn on the LEDs 24 using a user interface on a remote device 35, which will be discussed in greater detail below.

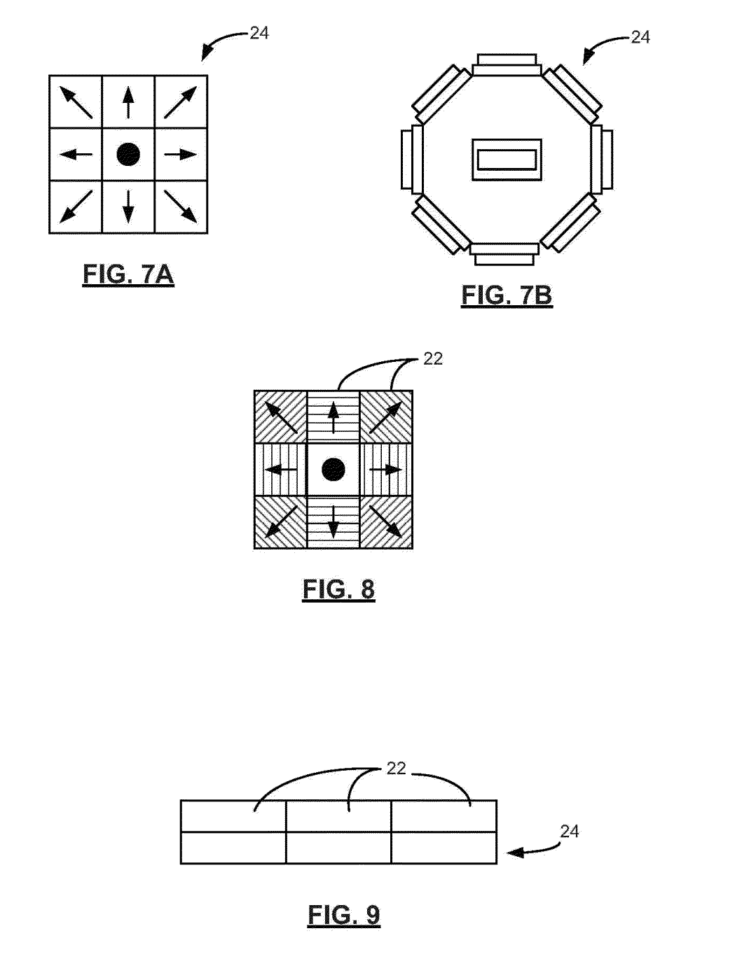

In some embodiments, and with reference to FIGS. 8 and 9, an array of LEDs may be overlaid with a plurality of prisms 22. In this embodiment, the LEDs may be facing a single direction, but may have their light directed in a plurality of directions by the plurality of prisms 22, as shown in FIG. 8. When an object is sensed in the target area, certain LEDs of the LED array may be operated to emit light that, when directed by the prism 22 emits light in the direction of the object sensed in the target area. The overlaying of the prisms 22 on the array of LEDs 24 is perhaps best illustrated in FIG. 9. The configurations shown in FIGS. 7A-9 are, of course, exemplary in nature, and may be rearranged while still accomplishing the goals, features, and objectives of the present invention.

Accordingly, the security light 10 according to an embodiment of the present invention provides directional illumination of portions of the target area based on the location within the target area where the motion is detected, or based on the location within the target area where an object is detected. As indicated above, the target area may be divided into an array of target areas, i.e., the target area may include multiple target areas. Each target area may be directed to a specific geographic location within the sensing area. It is contemplated that the array of target areas may overlap with one another, i.e., adjacent target areas may overlap with one another to advantageously ensure that there is not an area within the target area that goes undetected. As perhaps best illustrated in FIGS. 7A-7B, the bank of LEDs may be split into an array of LEDs. As illustrated in FIG. 7A, the array of LEDs may be positioned to face in different directions, i.e., different orientations. Accordingly, upon sensing movement or detecting the presence of an object in a particular portion of the target area, the LED in the array of LEDs facing that particular direction may be illuminated. The security light 10 according to an embodiment of the present invention advantageously illuminates the portion of the target area where the motion is detected, or where an object may be detected, i.e., where the event has occurred.

This advantageously increases the efficiency of the security light 10 by only illuminating the area within the target area where an event has been sensed. An event may, for example, be defined by an object located within a portion of the target area, or movement within the target area. As indicated above, the sensor may be in communication with the time-keeping device to provide for a delay to allow for the events to be classified as an event suitable for moving the light source 24 of the security light 10 from the off state to the on state. In other words, the light source 24 of the security light 10 is only illuminated in the direction where the event occurred if it is determined that the light source 24 should be activated, i.e., upon determining that an event has actually occurred.

The processor can process the data received from the camera 12 and/or the sensor 18 so that other LEDs of the array of LEDs may be activated to illuminate different portions of the target area if it is determined that the object has moved from one portion of the target area to another portion of the target area. In such an embodiment, it is contemplated that the portion of the target area that was initially illuminated may remain illuminated as another portion of the target area is illuminated by at least one of the LEDs in the array of LEDs 24. In some embodiments, it is also contemplated that the initial LED that was moved to the on state to illuminate the portion of the target area where the event originally occurred may be moved to the off state upon sensing that an event is no longer occurring in that portion of the target area. Furthermore, in some embodiments, where the detected object is determined to be in motion, an anticipated future location of the detected object may be estimated by the processor, and at least one of the LEDs of the array of LEDs may be illuminated to emit light in the direction of the anticipated future location. The embodiment of the LEDs 24 illustrated in FIG. 7B is another arrangement of the array of LEDs that advantageously provides for illumination of the target area in many different directions. Those skilled in the art will appreciate that the configurations of the array of LEDs illustrated in FIGS. 7A-7B are not meant to be limiting in any way but, instead, are provided for exemplary purposes.

As perhaps best illustrated in FIG. 8, the LEDs may all be similarly positioned, and the direction in which the light from the light source 24 of the security light 10 is emitted may be manipulated using a prism 22. The prism 22 may include an array of directional prisms positioned over the LEDs. Accordingly, upon detecting an event that occurs within a particular portion of the target area, the LEDs 24 behind a prism 22 facing in the direction of the target area where the event was detected may be illuminated, thereby emitting light in the direction of the target area where the event was detected. Again, this advantageously enhances the efficiency of the security light 10 according to an embodiment of the present invention.

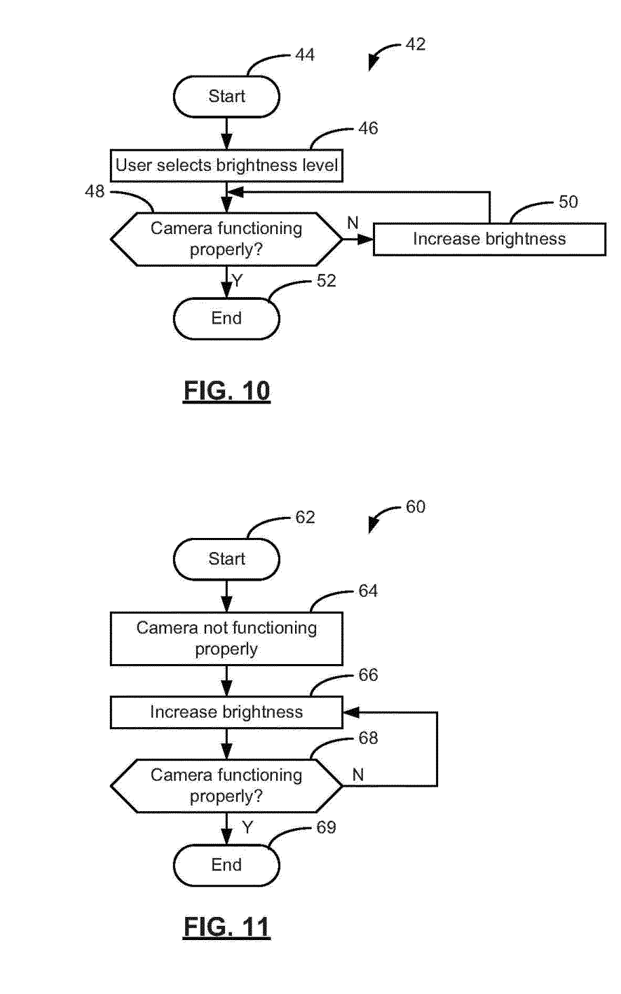

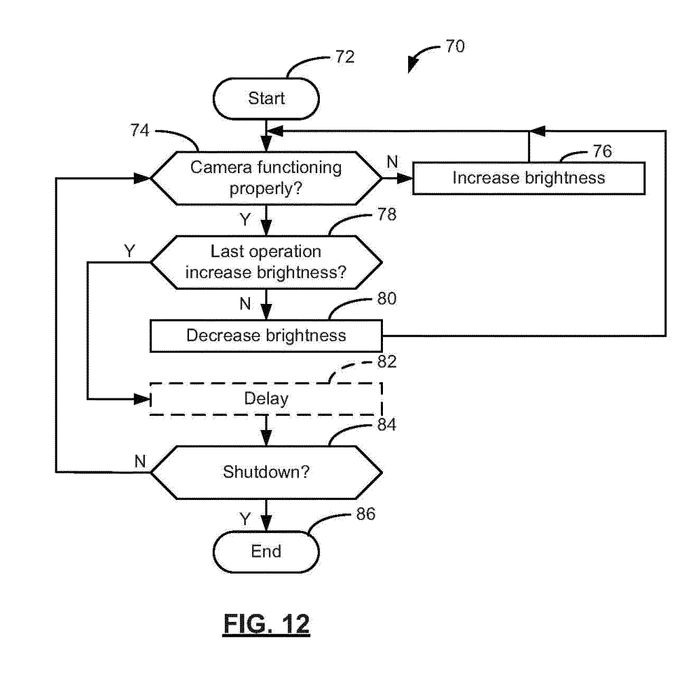

Referring now to FIGS. 10-12, calibrating aspects of a security light as described herein above of an embodiment of will be discussed in greater detail. For instance, and with reference to flowchart 42 of FIG. 10, from the start (Block 44) a user may select a brightness level using a remote device (Block 46). The sensor 18 may check if the camera 12 is functioning properly at Block 48, and may increase the brightness at Block 50 if the camera 12 is not functioning properly. Once the brightness is increased, the sensor 18 may again check if the camera 12 is functioning properly at Block 48. If the camera 12 is functioning properly at Block 48, the process may end at Block 52. This prevents a user from selecting a brightness that is below a minimum brightness requirement for the camera 12 to work properly. More specifically, in order for the security camera 12 of the luminaire 10 according to an embodiment of the present invention to properly function, a certain amount of light must be present. If, however, there is more than the minimum amount of light necessary for the security camera to function, then the security light 10 may be considered somewhat inefficient or, more accurately, not as efficient as it possibly can be. Accordingly, the method set forth in flowchart 42 of FIG. 10 indicates one way in which a minimum brightness level of the light source of the security light 12 may be set. That is, the method set forth in FIG. 10 demonstrates a manual method of increasing and decreasing the brightness of the light source 24 of the security light 12 according to an embodiment of the present invention to ensure that the security light 12 is operating as efficiently as possible.

Referring now to flowchart 60 of FIG. 11, a method of self-calibrating a security light as described hereinabove according to an embodiment of the present invention will be discussed. As will be discussed in greater detail below, this embodiment of operating the security light 12 advantageously eliminates the need for initial user input. From the start (Block 62), the sensor 18 may detect that the camera is not functioning properly at Block 64. This may be caused by any number of reasons, but the one of the problems that the various embodiments of the present invention aims to solve is a malfunctioning of the camera due to brightness levels not being high enough. Accordingly, the brightness may then be increased (Block 66), and the sensor 18 may check if the camera 12 is functioning properly at Block 68. If the camera 12 is still not functioning properly, the brightness may be increased again at Block 66. If, however, the camera 12 is functioning properly at Block 68, then the method may end at Block 69. This method may prevent the light source on the security light 10 from becoming too dim for the camera 12 to function.

The function described with reference to the flow chart 60 illustrated in FIG. 11 may be carried out at any time. For example, the self-calibrating function may be carried out as an initialization process when the security light 10 is first installed. Similarly, the self-calibrating function may be carried out as ambient light levels in the environment where the security light is positioned are sensed. The various embodiments of the present invention also contemplate that the self-calibrating function may be carried out based on a prompt, or command, received from a user. This prompt or command may be received from a user device. More particularly, the user device may, for example, be a computer, cell phone, smart phone, tablet, PDA or the like. In such an embodiment of the security light 10 according to an embodiment of the present invention, the security light may be positioned in communication with a network, and may receive signals or data to operate through the network. The data may be related to detection of an object in the target area and may be transmitted upon detection of an object in the target area. In some embodiments, the data may be transmitted to a cloud so that remote computerized devices may be able to view and monitor the activity of the luminaire. The data may include still images, video, audio and time stamps or any other information as known to a skilled artisan. The data may also be transmitted to a security company and/or directly to a user device. Transmission of the data to the security company and/or user device may occur when a defined object is detected in the target area for a period of time as set in the parameters. Additional details regarding communication of signals to the security 10 can be found in U.S. Provisional Patent Application Ser. No. 61/486,314 titled Wireless Lighting Device and Associated Methods, as well as U.S. patent application Ser. No. 13/463,020 titled Wireless Pairing System and Associated Methods and U.S. patent application Ser. No. 13/269,222 titled Wavelength Sensing Light Emitting Semiconductor and Associated Methods, the entire contents of each of which are incorporated herein by reference

The luminaire 10 may be programmed to recognize a defined object and may not illuminate a target area upon detecting the defined object. Additionally, the luminaire may be programmed to modify its timing sequence when a defined object is sensed so that the lights may stay on longer or shorter than a predefined default setting as determined by the user for a particular object. A defined object may be any object that may be defined by a user as known to skilled artisans. A defined object may vary in size from a small rodents and vermin to larger animals such as deer and the like. A defined object may also include a vehicle. In an embodiment, the luminaire 10 may be equipped to identify indicia and accord significance to certain indicia on an object such as a license plate or name plate.

Various embodiments of the security light 10 according to the present invention contemplate that the sensor 18 may be provided by the camera 12, and that operation of the calibrating feature can be carried out based on sensing ambient light levels. For example, the sensor may be an ambient light sensor and may determine a level of ambient light in the environment where the security light is located. The ambient light sensor may generate data indicating the ambient light level, and communicate that data to a controller of the security light. The security light may also include a processor that processes a signal received from the ambient light sensor in order to carry out various functions based on the data received from the ambient light sensor.

In some embodiments of the security light 10 according to the present invention, the light source is movable between an on state and an off state based on the data received from the ambient light sensor. For example, it is preferable that the light source not be activated when the ambient light level is sensed to be high, i.e., during the day or when the lighting in the environment is suitable to light the area around the security light 10. Therefore, the controller may cause the light source to be positioned in the off state when the ambient light sensor senses an ambient light level above a threshold level. Similarly, the light source of the security light 10 according to an embodiment of the present invention may be positioned in the on state when the ambient light sensor senses an ambient light level below the threshold level. The brightness of the light emitted from the luminaire 10 may also be variable depending on the time of day and the size of the object detected in the target area.

Referring now to flowchart 70 of FIG. 12, an automatic method for ensuring that the luminaire 10 functions at minimal brightness is shown. Beginning at Block 72, the sensor 18 may check if the camera 12 is functioning properly (Block 74). If the camera 12 is not functioning properly, the brightness may be increased at Block 76, and the sensor 18 may check if the camera 12 is functioning properly again (Block 74). If the camera 12 is functioning properly at Block 74, then it may be determined whether the last operation was to increase luminaire 10 brightness. If the last operation was not to increase brightness, then the luminaire 10 may decrease brightness (Block 80) and the sensor 18 may check if the camera 12 is functioning properly again at Block 74. If the last operation was to increase brightness at Block 78, however, then an optional delay may occur (Block 82). A delay may prevent unnecessary checking of the brightness level and the functionality of the camera 12, wasting energy. It may then be determined whether a shutdown command was received at Block 84. If a shutdown command is not received, the sensor 18 may check for camera 12 functionality again at Block 74. If a shutdown command is received, the process may end at Block 86.

The method described in FIG. 12 may advantageously allow for the light source of the luminaire 10 to be dimmed to conserve power. The light source may, of course, be periodically checked to ensure that it is at its minimum effective brightness for the camera 12. Additionally, this process may be done automatically or by a user, as discussed above.

The security light 10 may additionally include a time-keeping device in communication with the controller to cause the light source 24 to turn on or off at certain times. This may advantageously prevent the light source 24 of the security light 10 from being used when it is not necessary, such as a bright day. Additionally, the time-keeping device may be used to determine when the security light 10 calibrates itself, facilitating the optional delay mentioned above.

A method aspect of the present invention is illustrated in the flowchart 500 and may include illuminating a target area upon sensing an object using a luminaire. The luminaire, as described above, may include a wall mount, a driver circuit housing connected to the wall mount, a camera housing connected to the driver circuit housing, a light source housing connected to the camera housing, a light source array carried by the light source housing, the light source including a plurality of light sources, a prism carried by the light source housing adjacent the light source array, a heat sink in thermal communication with the light source array and carried by the light source housing, a camera carried by the camera housing, a sensor carried by the camera housing and a driver circuit carried by the driver circuit housing.

From the start (Block 502) The method may include defining parameters for a defined object and detecting an object (Block 504) to define a detected object. The method may further include determining (Block 506) if the detected object is a defined object. A defined object is preferably an object that a user may define to take a particular action. For example, a defined object may be a vehicle of a user. The user may then program the luminaire to take a particular action based on detection of the defined object. The particular action may be to do nothing, i.e., do not activate the luminaire. The particular action may, for example, be to illuminate the light source array of the luminaire for an amount of time. Alternatively, the particular action may be to illuminate the light source array at a particular brightness. The present invention also contemplates that the luminaire may be pre-programmed with various objects that are common to some environments. For example, it is contemplated that the luminaire may be programmed to detect certain wildlife such as, for example, deer, dogs, cats, moose, antelopes, buffalo, horses, possums, armadillos, and vermin in general. Accordingly, upon detection of such pre-programmed objects, the lighting device may take the particular action, which may be selected from the actions described above, or which may be any other action.

It is further contemplated that the luminaire according to embodiments of the present invention may include a timer connected to the controller. The timer may provide time data to the controller to operate the luminaire. For example, upon detection of an object that is a defined object, and upon cross-referencing various time data, the luminaire may activate to take an action selected from the actions described above. Further, it is contemplated that the luminaire, upon activation, may emit light at a particular brightness depending on a time of day.

If it is determined at Block 506 that the detected object is a defined object, then the particular action, described above, is taken at Block 505. Thereafter, the luminaire continues to detect an object at Block 504. If, however, it is determined at Block 506 that an object is detected, but that the detected object is not a defined object, then the luminaire is activated to emit light in the direction of the detected object at Block 508. The luminaire may be activated to emit light in the direction of the detected object in a number of ways. As described above, only certain light sources of the luminaire may be activated to direct light in the direction, or vicinity, of the detected object. Alternately, or in addition to, the light may be directed in the vicinity of the detected object by directional prisms of the optic. Additional information regarding directing the light emitted from the light source is provided above.

At Block 510, it is determined whether or not the detected object remains in the vicinity. The vicinity may be defined by a user, or maybe predefined within the luminaire. Further, those skilled in the art will appreciate that the vicinity is also referred to herein as the sensed area, and may be adjusted by the user as desired. If it is determined at Block 510 that the detected object means within the vicinity, and the luminaire remained activated at Block 508. If, however, it is determined at Block 510 that the detected object is no longer within the vicinity, then the luminaire is deactivated at Block 512. Thereafter, the method is ended at Block 514.

A skilled artisan will note that one or more of the aspects of the present invention may be performed on a computing device. The skilled artisan will also note that a computing device may be understood to be any device having a processor, memory unit, input, and output. This may include, but is not intended to be limited to, cellular phones, smart phones, tablet computers, laptop computers, desktop computers, personal digital assistants, etc. FIG. 15 illustrates a model computing device in the form of a computer 110, which is capable of performing one or more computer-implemented steps in practicing the method aspects of the present invention. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 110 may also include a cryptographic unit 125. Briefly, the cryptographic unit 125 has a calculation function that may be used to verify digital signatures, calculate hashes, digitally sign hash values, and encrypt or decrypt data. The cryptographic unit 125 may also have a protected memory for storing keys and other secret data. In other embodiments, the functions of the cryptographic unit may be instantiated in software and run via the operating system.

A computer 110 typically includes a variety of computer readable media. Computer readable media can be any available media that can be accessed by a computer 110 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 8 illustrates an operating system (OS) 134, application programs 135, other program modules 136, and program data 137.

The computer 110 may also include other removable/non-removable, volatile/nonvolatile computer storage media. By way of example only, FIG. 15 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives, and their associated computer storage media discussed above and illustrated in FIG. 15, provide storage of computer readable instructions, data structures, program modules and other data for the computer 110. In FIG. 15, for example, hard disk drive 141 is illustrated as storing an OS 144, application programs 145, other program modules 146, and program data 147. Note that these components can either be the same as or different from OS 134, application programs 135, other program modules 136, and program data 137. The OS 144, application programs 145, other program modules 146, and program data 147 are given different numbers here to illustrate that, at a minimum, they may be different copies. A user may enter commands and information into the computer 110 through input devices such as a keyboard 162 and cursor control device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 15. The logical connections depicted in FIG. 15 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 15 illustrates remote application programs 185 as residing on memory device 181.

The communications connections 170 and 172 allow the device to communicate with other devices. The communications connections 170 and 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

Referring now to FIG. 14, a model user interface 200 is shown in use on a remote device 35. The remote device 35 may advantageously be a mobile computing device, such as a smartphone or a laptop. The user interface 200 may include a camera feed 202 from the camera 12, which may demonstrate a brightness that is selected. A user may have the option to manually adjust brightness using slider 204, or automatically adjust brightness using button 206. Once the user is satisfied with the chosen brightness, the user may select the OK button 208 to save the adjustments, or the cancel button 210 to cancel the adjustments. This model user interface 200 is merely exemplary in nature, and is not intended to be limiting. Many other additional user interfaces 200 may readily come to mind of one skilled in the art having had the benefit of this disclosure, and are intended to be included herein. It is also contemplated that the user interface may be used to receive signals from the security light 10 indicating various conditions. For example, upon the occurrence of an event, it is contemplated that the security light 10 according to an embodiment of the present invention may send an alert to the user interface 200. Thereafter, it is contemplated that the user interface may be used to monitor the target area. Further, it is contemplated that the processor of the security light 10 may, in connection with the camera 12, capture images that occur surrounding the time of the event, and may stream those images to the user interface 200.

Referring to FIG. 18, an alternative embodiment of the luminaire 50 according to the present invention may include a first light source housing 20a and a second light source housing 20b. Although some of the elements may not be illustrated in FIG. 18, a first light source array 36a may be carried by the first light source housing 20a where the first light source array may include a plurality of light sources. The luminaire 50 may further include a second light source array 36b which may be carried by the second light source housing 20b where the second light source array 36b may include a plurality of light sources. A skilled artisan will appreciate that luminaire 50 may also include additional elements as described in FIG. 15 and FIG. 6.

The first camera 12a and first sensor 18a may be carried by the first camera housing 20a and the second camera 12b and second sensor 18b may be carried by the second camera housing 20b. A controller 37 may be in electrical communication with the first and second cameras 12a, 12b and the first and second sensors, 18a and 18b respectively.

The luminaire 50 may also include first and second beacons 35a and 35b respectively that include one or more LEDs. The controller 37 may also be positioned in electrical communication with the emergency alert system 68, the first and second light source arrays 36a and 36b respectively and the first and second beacons 35a and 35b. The first and second light source arrays 36a and 36b respectively may be capable of emitting illuminating light. The controller 37 may be configured to receive an emergency alert from the emergency alert system 68 and may be further configured to operate the light source to emit light within a wavelength range associated with a color responsive to the emergency alert, where the color of the light is associated with a particular emergency.

The controller 37 may also be configured to utilize the first and second cameras, 12a and 12b respectively, to transmit images and/or video to a third party over the network. The third party may be the owner of the premises, emergency response personnel, a security agency or any other entity as designated by the owner of the emergency alert system 38.

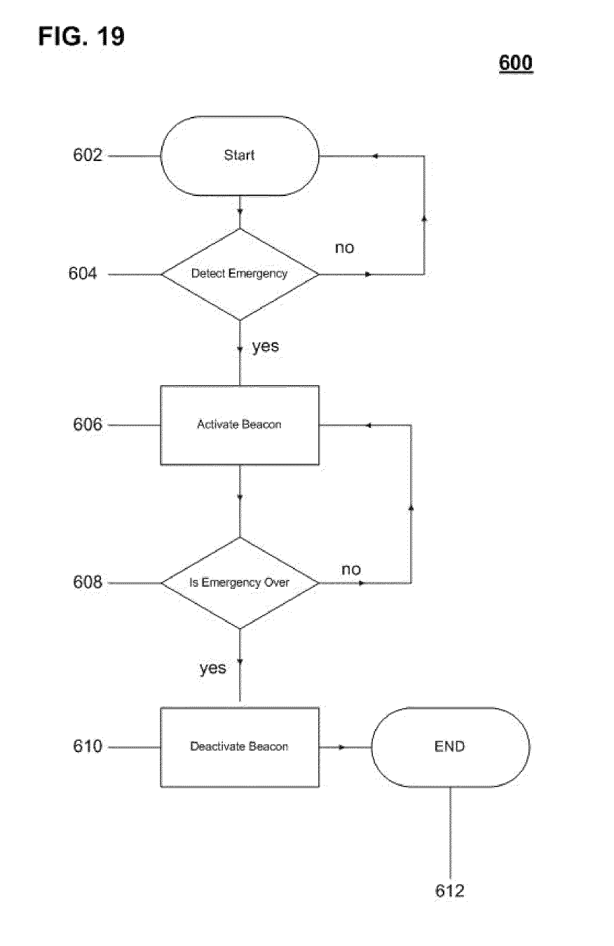

Another method aspect of the present invention is illustrated in flowchart 600 of FIG. 19 and may include a luminaire illuminating an area upon sensing an emergency. The luminaire, as described above, may include a wall mount, a driver circuit housing connected to the wall mount and a sensor housing connected to the driver circuit housing. A light source housing may be connected to the camera housing and may carry a light source array that may include a plurality of light sources. A sensor may also be carried by the sensor housing. The luminaire may also include a controller which may be positioned in electrical communication with an emergency alert system, the sensor and the light source.

From the start (Block 602), the method may include detecting an emergency (Block 604). An emergency as described above may include a medical emergency, an alert triggered by a fire and/or smoke and/or carbon monoxide detector, damage to the premises or a manual indication of an emergency by a user, or any other type of emergency, as would be readily understood by those skilled in the art, after having had the benefit of reading this disclosure. When the emergency is detected, the emergency beacon is activated (Block 606). The beacon may be operated by the controller to emit light in a predefined pattern in an identical manner as the light source described earlier. The controller may continue to operate the beacon until the emergency is over (Block 608). The controller may decide that an emergency is over after a default time period has elapsed or may operate until it is turned off. In an alternative embodiment, if the beacon is not turned off after a default time period, it may cycle on and off for a preset time or until deactivated (Block 610). The method terminates at Block 612.

The method may further include operating the light source to emit light in a predefined pattern. The controller may cause the light source to rotate or remain steadily burning to signal an emergency. The controller may also cause the light source to operate as a strobe light. A skilled artisan will appreciate that a light source including LED lights may be programmed with a wider variety of flash patterns because of their ability to be switched directly by electronics.

The method may further include operating the controller which may operate the light source to emit light within a wavelength range defined as a visible light communication spectrum with a predefined pattern that is configured to conform to a visible light communication standard. The predefined pattern may be configured to transmit information to a receiving device via visible light communication. The light source may be caused to emit a code during an emergency such as an SOS signal via Morse code. During an emergency, the default setting for the controller may be to emit a light of wavelength substantially between a range of 450 nm to 495 nm.

Many modifications and other embodiments of the invention will come to the mind of one skilled in the art having the benefit of the teachings presented in the foregoing descriptions and the associated drawings.

What is claimed is:

1. A luminaire comprising:
a wall mount;
a driver circuit housing connected to the wall mount;
a sensor housing connected to the driver circuit housing;
a light source housing connected to the sensor housing;
a light source array carried by the light source housing, the light source array including a plurality of light sources;
a sensor carried by the sensor housing; and
a controller positioned in electrical communication with an emergency alert system, the sensor and the light source;
wherein the plurality of light sources are capable of emitting illuminating light;
wherein the controller is configured to receive an emergency alert from the emergency alert system;
wherein the controller is configured to operate the light source to emit light within a wavelength range associated with a color responsive to the emergency alert; and
wherein the color of the light emitted is associated with a particular emergency.

2. The luminaire according to claim 1 wherein the controller is configured to operate the light source to emit light in a predefined pattern.

3. The luminaire according to claim 2 wherein the controller is configured to operate the light source to emit light within a wavelength range defined as a visible light communication spectrum; wherein the predefined pattern is configured to conform to a visible light communication standard; and wherein the predefined pattern is configured to transmit information to a receiving device via visible light communication.

4. The luminaire according to claim 1 wherein the light source is a light-emitting diode (LED).

5. The luminaire according to claim 1 wherein the wavelength of the light emitted in response to the emergency alert is from about 450 nm to about 495 nm.

6. The luminaire according to claim 1 further comprising a speaker in electrical communication with the controller; wherein the controller is configured to transmit at least one of emergency instructions and an audible alert upon receipt of an emergency alert to the speaker.

7. The luminaire according to claim 1 wherein the controller is positioned in electrical communication with a network; and wherein the controller is configured to relay the received emergency alert via the network to a remote computerized device.

8. The luminaire according to claim 1 wherein the controller causes a bracelet worn by a user to at least one of vibrate and flash.

9. The luminaire according to claim 1 wherein the emergency alert system is at least one of a security system, a fire detection system, a smoke detection system, a carbon monoxide detection system, and a damage detection system.

10. A luminaire comprising:
a first light source housing;
a second light source housing;
a first light source array carried by the first light source housing, the first light source array including a plurality of light sources;
a second light source array carried by the second light source housing, the second light source array including a plurality of light sources;
a first camera housing associated with the first light source housing;
a second camera housing associated with the second light source housing;
a first camera carried by the first camera housing;
a second camera carried by the second camera housing;
a beacon comprised of one or more LEDs;
a controller positioned in electrical communication with the emergency alert system, the first and second camera, the first and second light source array and the beacon;
wherein the first and second light source arrays are capable of emitting illuminating light;
wherein the controller is configured to receive an emergency alert from the emergency alert system; and
wherein the controller is configured to operate the light source to emit light within a wavelength range associated with a color responsive to the emergency alert, where the color of the light is associated with a particular emergency.

11. The luminaire according to claim 10 wherein the first and second cameras transmit at least one of images and video over the network to a third party.

12. The luminaire according to claim 10 wherein the controller causes the beacon to emit light in a predefined pattern.

13. The luminaire according to claim 10 further comprising a speaker in communication with the controller wherein the controller transmits at least one of emergency instructions and an audible alert upon receipt of an emergency alert to the speaker.

14. The luminaire according to claim 10 wherein the controller is connected to a network and the controller relays the received emergency alert via the network to a mobile device.

15. The luminaire according to claim 10 wherein the wavelength range of the light emitted in response to the emergency alert conforms to a wavelength range that corresponds to a color associated with a particular emergency as predefined by emergency light code requirements.

16. The luminaire according to claim 10 wherein the controller is positioned in electrical communication with a network; and wherein the controller is configured to relay the received emergency alert via the network to a remote computerized device.

17. A method of emitting light associated with an emergency wherein the luminaire comprises a wall mount, a driver circuit housing connected to the wall mount, a sensor housing connected to the driver circuit housing, a light source housing connected to the camera housing, a light source array including a plurality of light sources that is carried by the light source housing, a sensor carried by the sensor housing, a controller positioned in electrical communication with an emergency alert system, the sensor and the light source, the method comprising:
detecting an emergency alert with the emergency system;
receiving the emergency alert from the emergency system;
operating the light source to emit light within a wavelength range associated with a color responsive to the emergency alert.

18. The method of claim 17 further comprising operating the light source to emit light in a predefined pattern.

19. The method of claim 17 further comprising operating the light source to emit light within a wavelength range defined as a visible light communication spectrum; wherein the predefined pattern is configured to conform to a visible light communication standard; and wherein the predefined pattern is configured to transmit information to a receiving device via visible light communication.

20. The method of claim 17 wherein the light emitted in response to the emergency alert is from about 450 nm to about 495 nm.
